(19) United States
(12) Patent Application Publication
(10) Pub. No.: US 2022/0191900 A1
(43) Pub. Date: Jun. 16, 2022

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaohong Zhang, Beijing (CN); Shaozhen Guo, Beijing (CN); Xiaolin Hou, Beijing (CN)

(73) Assignee: NTT DOCOMO, INC., Tokyo (JP)

(21) Appl. No.: 17/440,577

(22) PCT Filed: Mar. 20, 2019
(86) PCT No.: PCT/JP2019/011862

§ 371 Date: Sep. 17, 2021

(51) Int. Cl. H04W 72/12; H04W 72/04; H04L 1/18; H04L 5/00

(52) U.S. Cl. CPC H04W 72/1268; H04W 72/1289; H04L 5/0053; H04L 1/1812; H04W 72/0446

(57) ABSTRACT

A user terminal includes: a receiving section that receives one or more pieces of configuration information indicating a periodicity shorter than one slot; and a control section that controls transmission of a plurality of pieces of delivery confirmation information for a plurality of downlink shared channels, the plurality of pieces of delivery confirmation information being respectively received in a plurality of reception occasions configured by the configuration information. As a result, it is possible to appropriately control feedback of the plurality of pieces of delivery confirmation information for the plurality of downlink shared channels in which a periodicity shorter than one slot is configured.

### TECHNICAL FIELD

The present disclosure relates to a user terminal and a radio communication method in next-generation mobile communication systems.

### BACKGROUND ART

In the universal mobile telecommunications system (UMTS) network, the specifications of long term evolution (LTE) have been drafted for the purpose of further increasing high speed data rates, providing lower delays and the like (see Non Patent Literature 1). Further, the specifications of LTE-Advanced (third generation partnership project (3GPP) Rel. (Release) 10 to 14) have been drafted for the purpose of further increasing capacity and advancement of LTE (3GPP Rel. 8 and 9).

Successor systems to LTE (for example, also referred to as 5th generation mobile communication system (5G), 5G+ (plus), New Radio (NR), or 3GPP Rel. 15 or later) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

In a future radio communication system (hereinafter, also referred to as NR), dynamic grant-based transmission and transmission without dynamic grant are considered.

In the transmission without dynamic grant in the NR, it is also assumed that a periodicity shorter than one slot is configured by one piece or more pieces of configuration information (for example, “spsConfig” of a control element (information element) of radio resource control (RRC)).

However, in a case where transmission of a shared channel (for example, a downlink shared channel (physical downlink shared channel (PDSCH))) in a periodicity shorter than one slot is configured by one piece or more pieces of configuration information, feedback (transmission) of delivery confirmation information (may be referred to as hybrid automatic repeat request acknowledgement (HARQ-ACK), ACK/NACK, or the like) may not be appropriately controlled.

In this regard, an object of the present disclosure is to provide a user terminal and a radio communication method capable of appropriately controlling feedback of a plurality of pieces of delivery confirmation information for a plurality of shared channels (for example, PDSCH) in which a periodicity shorter than one slot is configured by one or more pieces of configuration information.

### Solution to Problem

A user terminal according to an aspect of the present disclosure includes: a receiving section that receives one or more pieces of configuration information indicating a periodicity shorter than one slot; and a control section that controls transmission of a plurality of pieces of delivery confirmation information for a plurality of downlink shared channels, the plurality of pieces of delivery confirmation information being respectively received in a plurality of reception occasions configured by the configuration information.

### Advantageous Effects of Invention

According to one aspect of the present disclosure, it is possible to appropriately control feedback of a plurality of pieces of delivery confirmation information for a plurality of shared channels (for example, PDSCH) in which a periodicity shorter than one slot is configured by one or more pieces of configuration information.

### BRIEF DESCRIPTION OF DRAWINGS

FIG. 1 is a diagram illustrating an example of HARQ-ACK feedback according to a first aspect.

FIG. 2 is a diagram illustrating another example of the HARQ-ACK feedback according to the first aspect.

FIG. 3 is a diagram illustrating still another example of the HARQ-ACK feedback according to the first aspect.

FIG. 4 is a diagram illustrating an example of HARQ-ACK feedback according to a second aspect.

FIG. 5 is a diagram illustrating another example of the HARQ-ACK feedback according to the second aspect.

FIG. 6 is a diagram illustrating still another example of the HARQ-ACK feedback according to the second aspect.

FIG. 7 is a diagram illustrating an example of HARQ-ACK feedback based on trigger information according to a fourth aspect.

FIG. 8 is a diagram illustrating another example of the HARQ-ACK feedback based on the trigger information according to the fourth aspect.

FIG. 9 is a diagram illustrating an example of a schematic configuration of a radio communication system according to one embodiment.

FIG. 10 is a diagram illustrating an example of a configuration of a base station according to one embodiment.

FIG. 11 is a diagram illustrating an example of a configuration of a user terminal according to one embodiment.

FIG. 12 is a diagram illustrating an example of a hardware configuration of the base station and the user terminal according to one embodiment.

### DESCRIPTION OF EMBODIMENTS

(Dynamic Grant-Based Transmission and Transmission Without Dynamic Grant)

In NR, dynamic grant-based transmission and transmission without dynamic grant are considered.

The dynamic grant-based transmission is UL transmission (for example, transmission of an uplink shared channel (for example, physical uplink shared channel (PUSCH))) or DL transmission (for example, transmission of physical downlink shared channel (PDSCH)) based on downlink control information (DCI). The DCI is also referred to as a dynamic grant or the like.

Incidentally, the DCI (for example, DCI format 0_0 or 0_1) used for scheduling of the PUSCH is also referred to as a UL grant or the like. Further, the DCI (for example, DCI format 1_0 or 1_1) used for scheduling of the PDSCH is also referred to as DL assignment or the like.

A cyclic redundancy check (CRC) bit scrambled with a predetermined RNTI (for example, a cell-radio network temporary identifier (C-RNTI)) may be added to (or included in) the DCI (dynamic grant) (or may be CRC-scrambled).

The transmission without dynamic grant is UL transmission (for example, PUSCH transmission) or DL transmission (for example, PDSCH transmission) periodically performed on the basis of configuration information (also referred to as a configured grant or the like) by higher layer parameters (for example, a radio resource control (RRC) parameter).

The UL transmission without dynamic grant is also referred to as configured grant-based transmission, UL transmission with configured grant, UL grant-free transmission, configured scheduling, and the like. The UL transmission may be controlled on the basis of the configuration information (for example, configured grant configuration information (ConfiguredGrantConfig)) configured by a higher layer.

The DL transmission without dynamic grant is also referred to as semi-persistent scheduling (SPS), DL SPS, configured DL assignment, or the like. The SPS is controlled on the basis of the configuration information (for example, SPS configuration information (sps-config)) configured by the higher layer.

In the DL transmission or UL transmission without dynamic grant, a UL resource is already allocated to a UE, the UE can perform UL transmission on its own initiative by using the configured resource, and thus implementation of low latency communication can be expected.

Incidentally, hereinafter, the DL transmission without dynamic grant is referred to as “SPS”, but is not limited thereto, and the DL transmission may be referred to as configured grant-based transmission, DL transmission with configured grant, configured scheduling, or the like.

Hereinafter, the UL transmission without dynamic grant is referred to as “configured grant-based transmission” but is not limited thereto, and the UL transmission may be referred to as UL SPS, SPS, or the like. The operation related to SPS in the present disclosure may be applied by replacing “SPS” and “PDSCH” with “configured grant” and “PUSCH”, respectively.

In the SPS, activation or deactivation (release) may be controlled by DCI (downlink control channel (physical downlink control channel (PDCCH)). The DCI may be CRC-scrambled with a predetermined RNTI (for example, configured scheduling RNTI (CS-RNTI)) different from the dynamic grant.

The SPS configuration information (sps-config) configured by the higher layer may include, for example, information indicating at least one of the following.

Information (for example, periodicity, semiPersistSchedIntervalDL) indicating a periodicity;

Information (for example, nrofHARQ-Processes, numberOfConfSPS-Processes) indicating the number of HARQ processes;

Information (for example, n1PUCCH-AN) regarding a resource (for example, a PUCCH resource) for the uplink control channel (for example, physical uplink control channel) used for transmission of HARQ-ACK; and

Table information (for example, an MCS table (mcs-Table)) used for deciding a modulation and coding scheme (MCS).

At least one of the SPS activation DCI and the release DCI may include at least one piece of the following information.

Information (time domain resource assignment) regarding the allocation of time domain resources (for example, one or more symbols)

Information (frequency domain resource assignment) regarding the allocation of frequency domain resources (for example, one or more physical resource blocks (PRB) (also referred to as resource blocks (RB))

Information regarding the MCS (for example, an MCS index)

Information (for example, a HARQ process number (HPN) and a HARQ process ID) indicating the HARQ process

Information (for example, redundancy version (RV)) indicating a redundant version

Information (for example, a downlink assignment index (DL assignment index)) regarding the DL assignment

Information (for example, a PUCCH resource indicator) regarding the PUCCH resource

Information (for example, a PDSCH-HARQ-ACK feedback timing indicator (PDSCH-to-HARQ feedback timing indicator)) regarding timing to feed back (transmit) the HARQ-ACK

Information (for example, a carrier indicator (CI)) regarding a carrier

Information (for example, a bandwidth part indicator (BI)) regarding a bandwidth part (BWP)

New data indicator (NDI)

In a case where the DCI which is CRC-scrambled with a predetermined RNTI (for example, CS-RNTI) satisfies a predetermined condition, the UE may recognize the DCI as DCI for activation, and may start reception of a PDSCH of a certain periodicity using the time domain resource and the frequency domain resource designated by the DCI. The predetermined condition may be, for example, the following:

an NDI field in the DCI is 0;

all bits of an HPN field in the DCI are 0; and

all bits of an RV field in the DCI are 0.

In a case where the DCI which is CRC-scrambled with a predetermined RNTI (for example, CS-RNTI) satisfies a predetermined condition, the UE may recognize the DCI as DCI for release, and may stop reception of the PDSCH of the certain periodicity using the time domain resource and the frequency domain resource designated by the DCI. The predetermined condition may be, for example, the following:

the NDI field in the DCI is 0;

all bits of the HPN field in the DCI are 0;

all bits of the RV field in the DCI are 0.

all bits of an MCS field in the DCI are 1; and

all bits of a frequency domain field in the DCI are 1.

Incidentally, in a case where the field in the DCI is included for each transport block (TB), the above condition may be applied to the activated TB.

The UE may expect to provide the HARQ-ACK according to the DCI for release after N symbols from the last symbol of the PDCCH which transmits the DCI for release. N may be determined on the basis of at least one of a processing capability of the UE, a subcarrier spacing for receiving the PDCCH, and a frequency range.

The Nth PDSCH transmission timing by the activated SPS may be decided on the basis of at least one of the periodicity configured by the SPS configuration information (sps-config), a system frame number (SFN) (SFNstart time) and a slot number (slot -start time) in which the first transmission of the PDSCH activated by the DCI for activation is performed, and the number (numberOfSlotsPerFrame) of slots per frame. For example, the Nth PDSCH transmission timing may be indicated by following Formula 1.

(numberOfSlotsPerFramexSFN+slot number in frame)=[(numberOfSlotsPerFramexSFN_{start_time}+slot_{start_time})+N×periodicity×numberOfSlotsPerFrame/10]modulo(1024×numberOf SlotsPerFrame) (Formula 1)

The HPN allocated to the PDSCH by the SPS may be derived on the basis of the periodicity configured by the SPS configuration information (sps-config), the number (numberOfSlotsPerFrame) of slots per frame, and the first PDSCH transmission timing decided as described above. For example, the HPN (HARQ process ID) associated with the slot where the DL transmission starts may be indicated by Formula 2 below.

HARQ process ID=[floor (CURRENT_slot×100/(numberOfSlotsPerFramexperiodicity))]modulo nrofHARQ−Processes

where CURRENT slot=[(SFN×numberOfSlotsPerFrame)+slot number in frame] (Formula 2)

As described above, the PDSCH transmission by the SPS in which activation or release is controlled by the DCI is also referred to as type 2 or the like. Incidentally, the activation or release of the SPS may not be controlled. The SPS in which activation or release is not controlled may also be referred to as type 1 or the like. In the case of type 1, the SPS configuration information (sps-config) may include at least one piece of information included in the activation DCI or the release DCI.

The SPS may be configured for each of at least one of a serving cell (also referred to as a cell, a carrier, a component carrier (CC), or the like.) and a BWP. The activation or release of the SPS may be controlled independently between the serving cells.

In the case of receiving the PDSCH by the SPS or receiving the DCI for release, the UE may generate one HARQ-ACK bit.

In NR, one or more HARQ-ACKs may be mapped to a HARQ-ACK codebook, and the HARQ-ACK codebook may be transmitted on a PUCCH resource instructed by predetermined DCI (for example, last DCI).

Here, the HARQ-ACK codebook may include bits for HARQ-ACK in at least one unit of a time domain (for example, a slot), a frequency domain (for example, a component carrier (CC)), a spatial domain (for example, a layer), a transport block (TB), and a group (code block group (CBG)) of code blocks configuring the TB. Incidentally, the CC is also referred to as a cell, a serving cell, a carrier, or the like. Further, the bit is also referred to as a HARQ-ACK bit, HARQ-ACK information, a HARQ-ACK information bit, or the like.

The HARQ-ACK codebook is also referred to as a PDSCH-HARQ-ACK codebook (pdsch-HARQ-ACK-Codebook), a codebook, a HARQ codebook, a HARQ-ACK size, or the like.

The number (size) of bits or the like included in the HARQ-ACK codebook may be decided in a semi-static or dynamic manner. The HARQ-ACK codebook of which the size is semi-statically decided is also referred to as a semi-static HARQ-ACK codebook, a type-1 HARQ-ACK codebook, a semi-static codebook, or the like. The HARQ-ACK codebook of which the size is dynamically decided is also referred to as a dynamic HARQ-ACK codebook, a type-2 HARQ-ACK codebook, a dynamic codebook, or the like.

Whether to use the semi-static HARQ-ACK codebook or the dynamic HARQ-ACK codebook may be configured in the UE by higher layer parameters (for example, pdsch-HARQ-ACK-Codebook).

In the case of the semi-static HARQ-ACK codebook, the UE may feed back, in a predetermined range, HARQ-ACK bits corresponding to the predetermined range regardless of the presence or absence of PDSCH scheduling. The predetermined range is also referred to as a predetermined window, a HARQ-ACK window, a HARQ-ACK bundling window, a HARQ-ACK feedback window, a bundling window, a feedback window, or the like.

In a case where the release DCI (for example, DCI format 1_0) or reception of the SPS is detected only in a primary cell (PCell), and a counter DAI indicated by a predetermined field value in the release DCI is 1, a fallback PUCCH format 0 or 1 may be used as the HARQ-ACK for the release DCI.

The SPS may be configured with not only a secondary cell (SCell) but also a special cell (SpCell). On the other hand, the SPS may not be configured in a plurality of serving cells in the cell group (the SPS may be configured in one serving cell per cell group).

The UE may not expect to receive the DCI for release of the SPS and the PDSCH scheduled by the dynamic grant in the same slot.

Incidentally, in the SPS of NR Rel. 15, a periodicity of 10 ms or more (for example, 10 ms, 20 ms, 32 ms, and the like) is supported. On the other hand, in the NR Rel. 16 or later, it is assumed that a periodicity (for example, a periodicity shorter than one slot) shorter than 10 ms is supported by the SPS.

However, in a case where the transmission of a PDSCH (also referred to as SPS PDSCH or the like) with a periodicity shorter than one slot is configured by one piece or more pieces of SPS configuration information (spsConfig), there is a possibility that feedback (transmission) of HARQ-ACK cannot be appropriately controlled. In this regard, the present inventors have studied a method of appropriately controlling feedback of the HARQ-ACK, and have reached the present invention.

Specifically, the present inventors have conceived separately feeding back a plurality of pieces of HARQ-ACK (also referred to as a HARQ-ACK bit, HARQ-ACK information, and the like) for a plurality of PDSCHs respectively received in a plurality of SPS occasions (opportunities) configured by one piece or more pieces of SPS configuration information (first aspect), performing feedback collectively (second aspect), performing bundling (third aspect), and controlling support or triggering of the feedback (fourth aspect).

Hereinafter, embodiments according to the present disclosure will be described in detail with reference to the drawings. Incidentally, the UE according to the present embodiment can be applied to a case where one or a plurality of SPSs are configured or activated by one piece or more pieces of SPS configuration information in one cell group, one serving cell, or one BWP.

Each piece of SPS configuration information may include information indicating a periodicity shorter than one slot. A plurality of SPSs which are simultaneously activated (or configured) may have at least one of different periodicities, different time domain resource assignments, and different frequency domain resource assignments. Alternatively, the plurality of SPSs which are simultaneously activated (or configured) may have at least one of the same periodicity, the same time domain resource assignment, and the same frequency domain resource assignment, and may have different time offsets.

In the present disclosure, the SPS configuration information may be paraphrased as the SPS. Further, the SPS opportunity may be paraphrased as a DL SPS opportunity, a reception opportunity, a reception period, a predetermined period, a predetermined timing, a PDSCH, an SPS PDSCH, and a periodicity. Further, the PUCCH resource may be paraphrased as the PUCCH.

(First Aspect)

In the first aspect, the UE may feed back a plurality of pieces of HARQ-ACK for a plurality of PDSCHs respectively received in a plurality of SPS occasions configured by one piece or more pieces of SPS configuration information (spsConfig) by using different PUCCH resources. At least one piece of SPS configuration information may indicate a periodicity shorter than one slot.

In the first aspect, it may not be assumed that the UE maps the HARQ-ACK for the plurality of PDSCHs received in the plurality of SPS occasions to one PUCCH resource. That is, the UE may map HARQ-ACK (1-bit HARQ-ACK) for one SPS opportunity to one PUCCH resource.

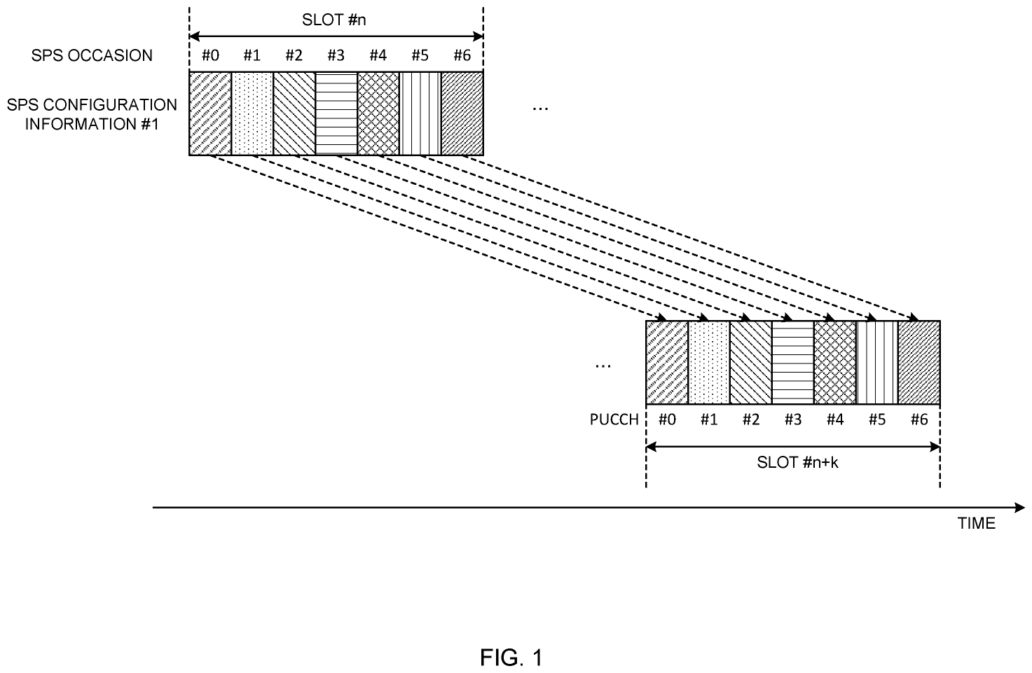

FIG. 1 is a diagram illustrating an example of HARQ-ACK feedback according to the first aspect. For example, in FIG. 1, it is assumed that a PDSCH with a periodicity (here, two symbol periodicity) shorter than one slot is configured by one piece of SPS configuration information #1.

As illustrated in FIG. 1, in a case where a first SPS opportunity #0 of a two symbol periodicity configured by the SPS configuration information #1 is started from a first symbol #0 of a slot #n, seven SPS occasions #0 to #6 may be provided in the slot #n including 14 symbols.

For example, in FIG. 1, each of the SPS occasions #0 to #6 includes two symbols, and the PDSCH is scheduled for the two symbols. Further, a HARQ process ID decided on the basis of the start timing of the SPS opportunity #0 may be assigned to the seven PDSCH of the SPS occasions #0 to #6. For example, different seven HARQ process IDs may be assigned to the SPS occasions #0 to #6.

As illustrated in FIG. 1, in a case where a plurality of SPS occasions are configured, HARQ-ACK for the plurality of PDSCHs received in the plurality of SPS occasions may be transmitted using a plurality of PUCCH resources allocated after a predetermined period k from each of the plurality of SPS occasions.

For example, in FIG. 1, the HARQ-ACK for the plurality of PDSCHs respectively received in the SPS occasions #0 to #6 may be transmitted using PUCCH resources #0 to #6 allocated after the predetermined period k from each of the SPS occasions #0 to #6.

The predetermined period k may be decided by the UE on the basis of at least one of a value of a predetermined field (for example, a PDSCH-HARQ-ACK feedback timing indicator field) in the DCI for activation and a value of a higher layer parameter (for example, a predetermined parameter in the SPS configuration information). Alternatively, the predetermined period k may be determined in advance in a specification.

The predetermined period k may be indicated by the number of predetermined time units. For example, in FIG. 1, the predetermined time unit is a slot, and the predetermined period k is indicated by k slots. As illustrated in FIG. 1, the HARQ-ACK for the PDSCH received in each SPS opportunity in slot #n may be transmitted by using each PUCCH in slot #n+k after K slots.

Alternatively, the predetermined time unit may be a time unit (also referred to as a sub slot, a mini slot, a half slot, or the like) configured with a number of symbols shorter than the slot or fewer than the slot. In a case where each SPS opportunity is equal to a sub slot, the HARQ-ACK for the PDSCH received in each SPS opportunity may be transmitted using the PUCCH after K sub slots of each SPS opportunity.

Each PUCCH resource may be decided by the UE on the basis of at least one of a value of a predetermined field (for example, a PUCCH resource indicator) in the DCI for activation and a value of a higher layer parameter (for example, a predetermined parameter (for example, n1PUCCH-AN) in the SPS configuration information or a predetermined parameter in the PUCCH configuration information (for example, PUCCHConfig)).

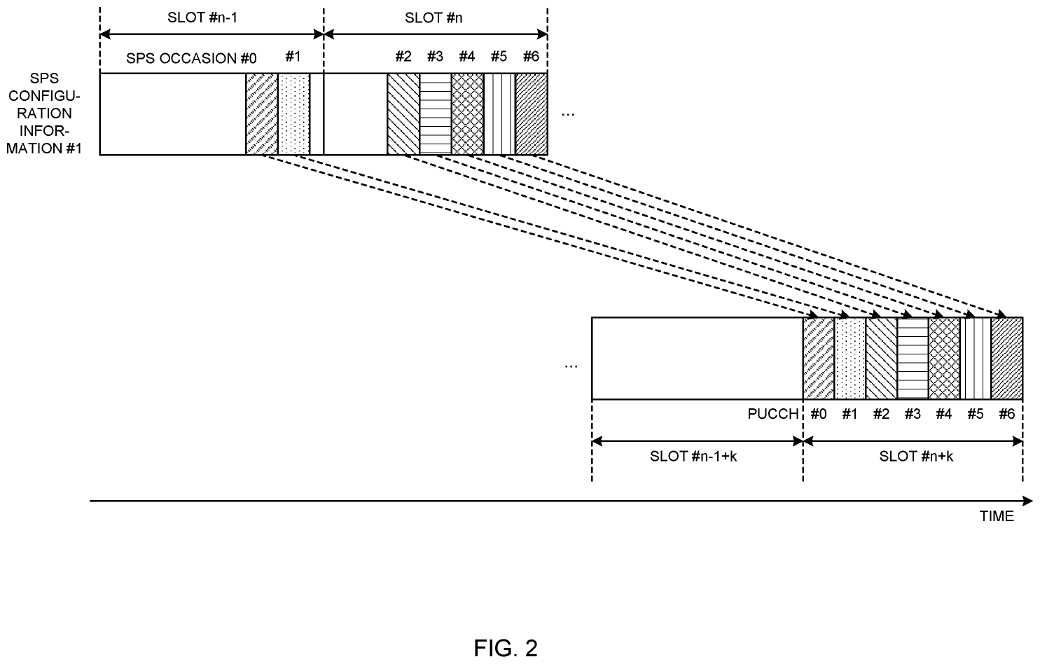

FIG. 2 is a diagram illustrating another example of HARQ-ACK feedback according to the first aspect. FIG. 2 is different from FIG. 1 in that a first SPS opportunity #0 of a two symbol periodicity configured by the SPS configuration information #1 is started in the middle of a slot #n−1, and a plurality of SPS occasions configured by the SPS configuration information #1 extend over a plurality of slots. A difference from FIG. 1 will be mainly described in FIG. 2.

As illustrated in FIG. 2, each SPS opportunity may be provided without straddling a boundary between slots. For example, in FIG. 2, the SPS opportunity #2 next to the SPS opportunity #1 may be provided in the slot #n in order to prevent the SPS opportunity #2 from straddling a boundary between the slot #n−1 and the slot #n. Incidentally, although not illustrated, the SPS opportunity may be provided across the boundary between slots.

The user terminal may report, to the NW, whether the SPS opportunity can be gained across the boundary between slots as UE capability signaling (the capability information of the UE) in advance. Incidentally, in addition to the UE capability signaling indicating whether the SPS opportunity is provided across the boundary between slots, the UE capability signaling indicating whether the PDSCH dynamically scheduled by the PDCCH is provided across the boundary between slots may be separately reported by different signaling.

Alternatively, in the user terminal, it may be assumed that the SPS opportunity is provided across the boundary between slots, but the PDSCH dynamically scheduled by the PDCCH does not cross the boundary between slots. As a result, resource assignment across the boundary between slots can be separately implemented in the SPS opportunity and the PDSCH dynamically scheduled by the PDCCH, and a circuit scale of the terminal can be reduced.

As illustrated in FIG. 2, each SPS opportunity may be provided on the basis of a slot configuration. For example, FIG. 2 illustrates an example in which symbols #0 to #5 of the slot #n are UL symbols, and symbols #6 to #13 of the slot #n are DL symbols. In the case illustrated in FIG. 2, the SPS occasions #2 to #6 in the slot #n may be arranged in the DL symbols #6 to #13 after the UL symbols #0 to #5.

Incidentally, the slot configuration may be decided by the UE on the basis of at least one of the higher layer parameter (for example, at least one of “TDD-UL-DL-ConfigurationCommon” and “TDD-UL-DL-ConfigDedicated” of the RRC control element) and a value of a predetermined field (for example, a slot format indicator (SFI) field) in the DCI (for example, DCI format 2_0).

As illustrated in FIG. 2, in a case where a plurality of SPS occasions are configured over a plurality of slots, HARQ-ACK for the plurality of PDSCHs received in the plurality of SPS occasions may be transmitted using the plurality of PUCCH resources allocated after the predetermined period k from each of the plurality of SPS occasions.

For example, in FIG. 2, it is assumed that a slot #n−1+k after the predetermined period k from the SPS occasions #0 and #1 in the slot #n−1 is a DL slot, and the next slot #n+k is a UL slot. In this case, the UE may transmit the HARQ-ACK for the PDSCHs received in the respective SPS occasions #0 and #1 by using the PUCCH resources #0 and #1 allocated to the UL slot #n+k.

On the other hand, the slot #n+k after the predetermined period k from the SPS occasions #2 to #6 in the slot #n is a UL slot. Therefore, the UE may transmit the HARQ-ACK for the PDSCHs received in the respective SPS occasions #2 to #6 by using the PUCCH resources #2 to #6 allocated to the UL slot #n+k.

In this manner, the feedback timing of the HARQ-ACK for the PDSCH received in each SPS opportunity may be decided by the UE on the basis of the predetermined period k and the slot configuration.

Incidentally, FIGS. 1 and 2 are merely examples, and the number of slots in which a plurality of SPS occasions provided by a single piece of SPS configuration information is arranged and the number of slots in which a plurality of PUCCH resources used for transmission of HARQ-ACK to a plurality of PDSCHs received in the plurality of SPS occasions are arranged are not limited to those illustrated.

For example, HARQ-ACK for a plurality of PDSCHs respectively received at a plurality of SPS occasions (for example, the SPS occasions #0 to #6 in FIG. 1) within a single slot may be fed back on a plurality of PUCCH resources across a plurality of slots.

HARQ-ACK for a plurality of PDSCHs respectively received at a plurality of SPS occasions (for example, the SPS occasions #0 to #6 in FIG. 2) within a plurality of slots may be fed back on a plurality of PUCCH resources across a plurality of slots.

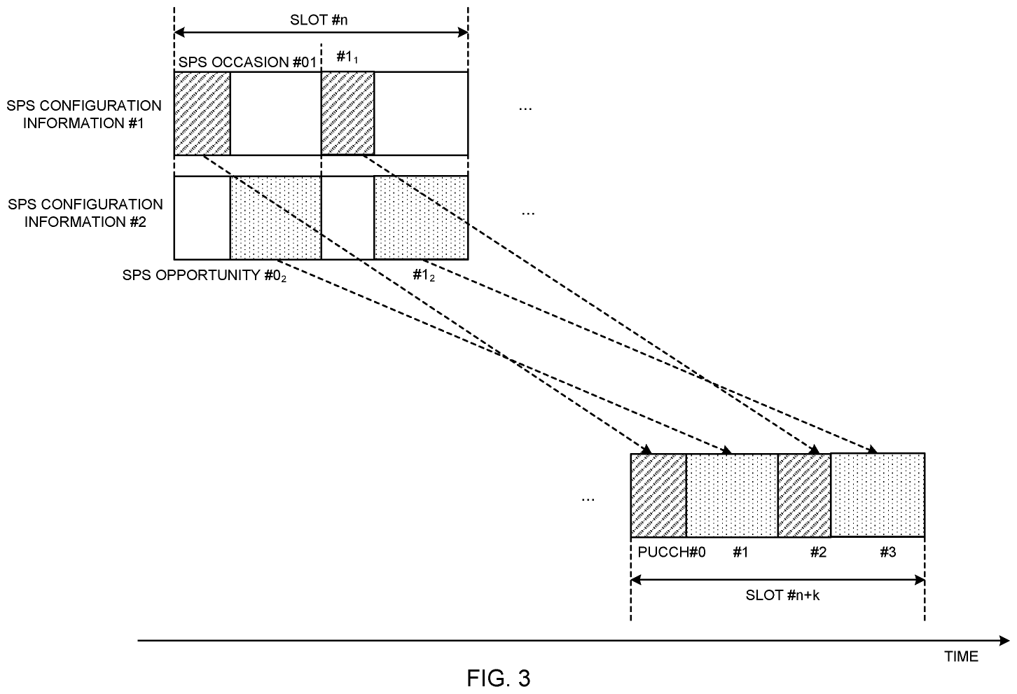

FIG. 3 is a diagram illustrating still another example of the HARQ-ACK feedback according to the first aspect. FIG. 3 is different from FIGS. 1 and 2 in that PDSCH transmission with a periodicity (here, seven symbol periodicity) shorter than one slot is configured by each of a plurality of pieces of SPS configuration information (here, the SPS configuration information #1 and #2). A difference from FIG. 1 will be mainly described in FIG. 3.

For example, in FIG. 3, it is assumed that the PDSCH of three symbols is configured in a seven symbol periodicity by the SPS configuration information #1. On the other hand, it is assumed that the PDSCH of four symbols is configured in a seven symbol periodicity by the SPS configuration information #2. Incidentally, FIG. 3 is merely an example, and the present invention is not limited thereto.

As illustrated in FIG. 3, in a case where a plurality of SPS occasions of different SPS configuration information are configured, HARQ-ACK for the plurality of PDSCHs received in the plurality of SPS occasions may be transmitted using the plurality of PUCCH resources allocated after the predetermined period k from each of the plurality of SPS occasions.

For example, in FIG. 3, HARQ-ACK for a plurality of PDSCHs respectively received in SPS occasions #0ᵢ and #1ᵢ (i=1, 2) of the SPS configuration information #1 and #2 may be transmitted using the PUCCH resources #0 to #3 allocated from the SPS occasions #0ᵢ and #1ᵢ after the predetermined period k.

Incidentally, in FIG. 3, a plurality of SPS occasions corresponding to a plurality of pieces of SPS configuration information is provided in the same slot #n, but the present invention is not limited thereto. The plurality of SPS occasions may be provided over a plurality of slots. In this case, the HARQ-ACK for the PDSCHs received in the plurality of SPS occasions may be fed back using a plurality of PUCCH resources in the same slot or a plurality of different slots.

In a case where a plurality of SPS occasions corresponding to a plurality of pieces of SPS configuration information are provided in the same slot #n, the HARQ-ACK for the PDSCHs received in the plurality of SPS occasions may be fed back using a plurality of PUCCH resources in different slots.

As described above, in the first aspect, the HARQ-ACK for the PDSCH received in one SPS opportunity configured by one piece of SPS configuration information is mapped to one PUCCH resource. Therefore, the UE can easily perform feedback control of HARQ-ACK for a plurality of PDSCHs received in a plurality of SPS occasions configured by one piece or more pieces of SPS configuration information.

(Second Aspect)

In a second aspect, the UE may feed back a plurality of pieces of HARQ-ACK for a plurality of PDSCHs respectively received in a plurality of SPS occasions configured by one piece or more pieces of SPS configuration information (spsConfig) by using a single PUCCH resource. At least one piece of SPS configuration information may indicate a periodicity shorter than one slot. In the second aspect, differences from the first aspect will be mainly described. The first aspect can be applied to a similar point to the first aspect.

In the second aspect, it may be assumed that the UE maps the HARQ-ACK for the plurality of PDSCHs received in the plurality of SPS occasions to one PUCCH resource. That is, the UE may map HARQ-ACK (one or more bits of HARQ-ACK) for one or more SPS occasions configured by one piece or more pieces of SPS configuration information to one PUCCH resource.

In the second aspect, a single PUCCH resource used for feedback of HARQ-ACK for a plurality of PDSCHs received in a plurality of SPS occasions within a predetermined window (also referred to as a predetermined range, a HARQ-ACK window, and the like) may correspond to (may be associated with) PDSCH reception in one (for example, last or first SPS opportunity) of the plurality of SPS occasions.

Specifically, the UE may feed back the HARQ-ACK for the plurality of PDSCHs respectively received in the plurality of SPS occasions after the predetermined period k from the last or first SPS opportunity among the plurality of SPS occasions in the predetermined window by using the single PUCCH resource.

In the second aspect, the number (also referred to as a payload size, a HARQ-ACK codebook size, and the like) of a plurality of HARQ-ACK bits transmitted on the single PUCCH resource may be configured by a higher layer parameter (for example, information in the SPS configuration information).

A plurality of PUCCH resources may be configured by higher layer parameters. Specifically, a plurality of PUCCH resource sets each including one or more PUCCH resources may be configured in the UE. The UE may select the single PUCCH resource from the PUCCH resource set decided on the basis of the HARQ-ACK codebook size. The single PUCCH resource may be selected on the basis of a value of a predetermined field (for example, the PUCCH resource indicator field) in the DCI for activation.

Alternatively, the single PUCCH resource may be configured by a higher layer parameter (for example, n1PUCCH-AN in the SPS configuration information). The single PUCCH resource may be any one of PUCCH formats 0, 1, 2, 3, and 4.

In the second aspect, the order of the HARQ-ACK bits in the HARQ-ACK codebook may be determined by at least one of an index of an SPS opportunity, a CC index, and an index of SPS configuration information (or SPS).

For example, in a case where a single SPS configuration information is configured (or activated), the order may be first in the time domain and second (that is, in the order of the earliest SPS opportunity) in the frequency domain or may be first in the frequency domain and later (that is, in the ascending (lower) order of the CC index) in the time domain.

In a case where a plurality of pieces of SPS configuration information is configured (or activated), the order may be first (that is, in the order of the earliest SPS opportunity) in the time domain, may be first (that is, in the ascending (lower) order of the CC index) in the frequency domain, or may be the order (for example, in the ascending order of the index of the SPS) of the index of the SPS configuration information (or SPS).

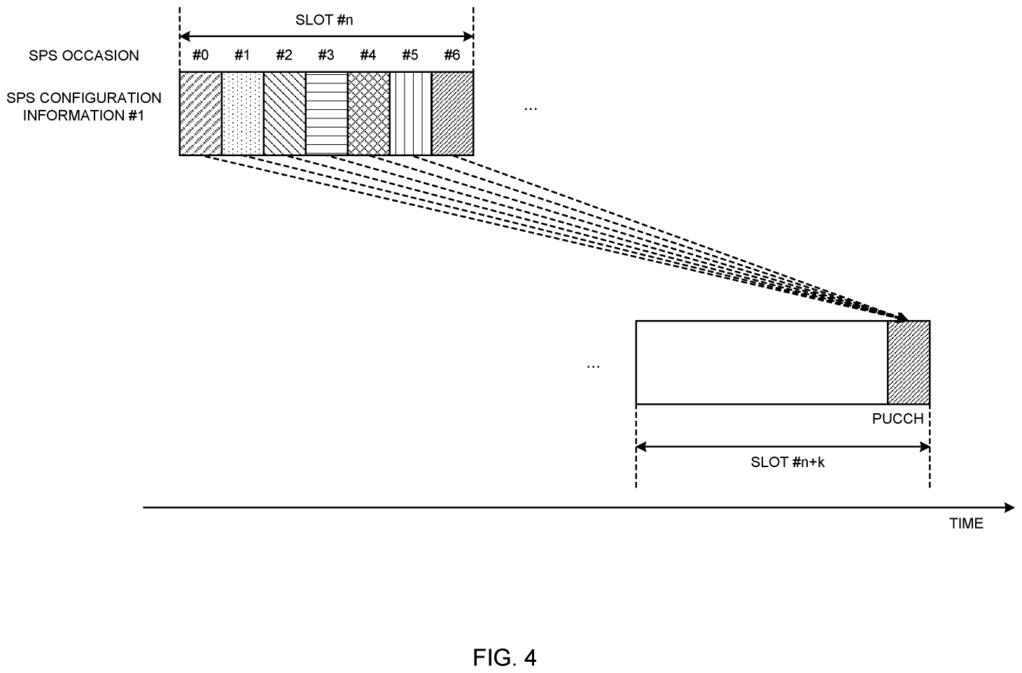

FIG. 4 is a diagram illustrating an example of HARQ-ACK feedback according to the second aspect. In FIG. 4, description of points similar to those in FIG. 1 will be omitted, and differences from FIG. 1 will be mainly described.

As illustrated in FIG. 4, in a case where a plurality of SPS occasions corresponding to one SPS configuration information #1 are configured within a predetermined window (here, the slot #n), HARQ-ACK for a plurality of PDSCHs received in the plurality of SPS occasions may be transmitted by using a single PUCCH resource allocated after the predetermined period k from one (for example, the first or last SPS opportunity) of the plurality of SPS occasions.

For example, in FIG. 4, HARQ-ACK for a plurality of PDSCHs respectively received in the SPS occasions #0 to #6 in a predetermined window may be transmitted by using the PUCCH resource #6 allocated after the predetermined period k from the last SPS opportunity #6.

The predetermined period k may be decided by the UE on the basis of at least one of a value of a predetermined field (for example, a PDSCH-HARQ-ACK feedback timing indicator field) in the DCI for activation and a value of a higher layer parameter (for example, a predetermined parameter in the SPS configuration information). Alternatively, the predetermined period k may be determined in advance in a specification.

The predetermined period k may be indicated by the number of predetermined time units. For example, in FIG. 4, the predetermined time unit is a slot, and the predetermined period k is indicated by K slots. As illustrated in FIG. 4, the HARQ-ACK for the PDSCHs received in the plurality of SPS occasions #0 to #6 in the predetermined window (slot #n) may be transmitted by using the PUCCH resource #6 in the slot #n+k after K slots.

Alternatively, the predetermined time unit may be a time unit (also referred to as a sub slot, a mini slot, a half slot, or the like) configured with a number of symbols shorter than the slot or fewer than the slot. In a case where each SPS opportunity is equal to a sub slot, the HARQ-ACK for the PDSCHs received in the plurality of SPS occasions within a predetermined window may be transmitted using a single PUCCH after K sub slots of a specific SPS opportunity (in FIG. 4, SPS opportunity #6).

The single PUCCH resource may be decided by the UE on the basis of at least one of a value of a predetermined field (for example, a PUCCH resource indicator) in the DCI for activation and a value of a higher layer parameter (for example, a predetermined parameter (for example, n1PUCCH-AN) in the SPS configuration information or a predetermined parameter in the PUCCH configuration information (for example, PUCCHConfig)).

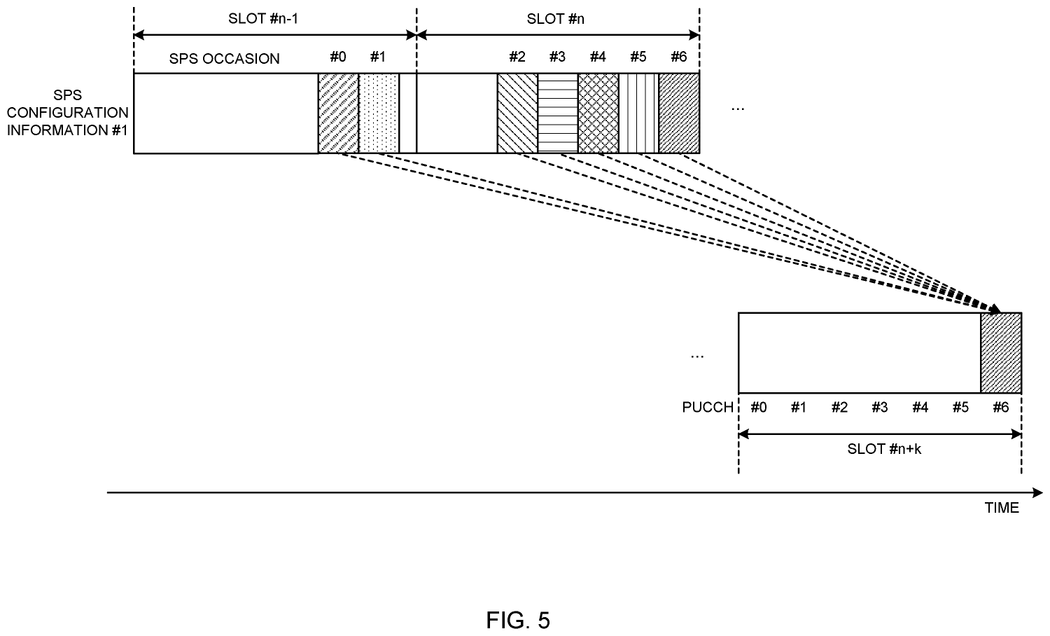

FIG. 5 is a diagram illustrating another example of the HARQ-ACK feedback according to the second aspect. In FIG. 5, description of points similar to those in FIG. 2 will be omitted, and differences from FIG. 2 will be mainly described.

FIG. 5 is different from FIG. 2 in that, in a case where a plurality of SPS occasions is configured by the SPS configuration information #1 over a plurality of slots, HARQ-ACK for the plurality of PDSCHs received in the plurality of SPS occasions is transmitted by using the single PUCCH resource #6 allocated after the predetermined period k from one (for example, SPS opportunity #6) of the plurality of SPS occasions.

For example, in FIG. 5, the predetermined window includes the SPS occasions #0 and #1 in slot #n−1 and the SPS occasions #2 to #6 in slot #n. In this case, the PUCCH resource #6 in the slot #n+k after the predetermined period k from the last SPS opportunity #6 of the SPS occasions #0 to #6 in the predetermined window may be used to transmit the HARQ-ACK codebook including the HARQ-ACK bits for the plurality of PDSCHs received in the SPS occasions #0 to #6.

Incidentally, the feedback timing of the HARQ-ACK for the PDSCHs received in the plurality of SPS occasions in the predetermined window may be decided by the UE on the basis of at least one of one (for example, last or first SPS opportunity) of the plurality of SPS occasions, the predetermined period k, and the slot configuration.

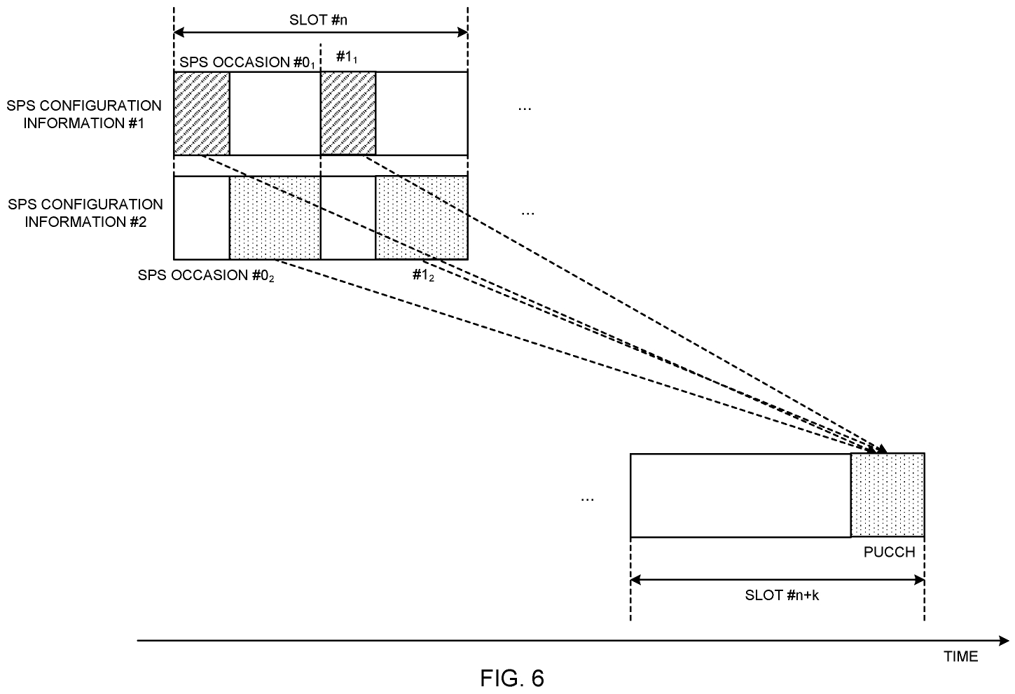

FIG. 6 is a diagram illustrating still another example of the HARQ-ACK feedback according to the second aspect. In FIG. 6, description of points similar to those in FIG. 3 will be omitted, and differences from FIG. 3 will be mainly described. As illustrated in FIG. 6, one or more SPS occasions corresponding to different SPS configuration information may be configured in a predetermined window (here, the slot #n).

As illustrated in FIG. 6, in a case where a plurality of SPS occasions #0ᵢ and #1ᵢ (i=1, 2) corresponding to different SPS configuration information #1 and #2 are configured within a predetermined window (here, the slot #n), HARQ-ACK for the plurality of PDSCHs received in the plurality of SPS occasions may be transmitted by using a single PUCCH resource allocated after the predetermined period k from one (for example, the first or last SPS opportunity) of the plurality of SPS occasions.

For example, in FIG. 6, HARQ-ACKs for a plurality of PDSCHs respectively received in SPS occasions #0ᵢ and #1ᵢ (i=1, 2) in a predetermined window may be transmitted by using a PUCCH resource allocated after the predetermined period k from the last SPS opportunity #1₂.

Incidentally, the feedback timing of the HARQ-ACK for the PDSCHs received in the plurality of SPS occasions in the predetermined window may be decided by the UE on the basis of at least one of one (for example, last or first SPS opportunity) of the plurality of SPS occasions, the predetermined period k, and the slot configuration.

In FIG. 6, a plurality of SPS occasions corresponding to a plurality of pieces of SPS configuration information are provided in the same slot #n, but the present invention is not limited thereto. The plurality of SPS occasions may be provided in a plurality of slots in a smiling manner.

As described above, in the second aspect, the HARQ-ACK for the PDSCH received in one or more SPS occasions configured by one piece or more pieces of SPS configuration information are mapped to one PUCCH resource. Therefore, compared with the first aspect, the UE can reduce the overhead due to the feedback of the HARQ-ACK.

(Third Aspect)

In a third aspect, the UE may control bundling of a plurality of pieces of HARQ-ACK for a plurality of PDSCHs respectively received in a plurality of SPS occasions configured by one piece or more pieces of SPS configuration information (spsConfig).

Here, the bundling of the plurality of pieces of HARQ-ACK may be taking the AND of the plurality of HARQ-ACK bits and generating a one-bit HARQ-ACK. The bundling of the plurality of pieces of HARQ-ACK may be performed in at least one of a time domain (for example, a plurality of SPS occasions configured by the same SPS configuration information), a frequency domain (for example, a plurality of carriers or a plurality of BWPs), and a plurality of pieces of SPS configuration information.

For example, as illustrated in FIG. 4 or 5, in a case where a plurality of SPS occasions are provided by single SPS configuration information #1 within a predetermined window, the UE may bundle HARQ-ACK corresponding to at least two of the plurality of SPS occasions and transmit the bundled HARQ-ACK by using a single PUCCH.

Alternatively, as illustrated in FIG. 6, in a case where a plurality of SPS occasions are provided by a plurality of pieces of SPS configuration information #1 and #2 within a predetermined window, the UE may bundle HARQ-ACK corresponding to the plurality of SPS occasions #0ᵢ and #1ᵢ for each SPS configuration information In this case, a plurality of pieces of HARQ-ACK bundled for each SPS configuration information #i may be transmitted by using a single PUCCH.

According to the third aspect, the UE bundles HARQ-ACK for the PDSCH received in one or more SPS occasions configured by one piece or more pieces of SPS configuration information and maps the HARQ-ACK to one PUCCH resource. Therefore, the number (HARQ-ACK codebook size) of bits of the HARQ-ACK mapped to one PUCCH resource can be reduced.

(Fourth Aspect)

In a fourth aspect, support or triggering of a plurality of pieces of HARQ-ACK for a plurality of PDSCHs respectively received in a plurality of SPS occasions configured by one piece or more pieces of SPS configuration information will be described. At least one piece of SPS configuration information may indicate a periodicity shorter than one slot.

The UE may support HARQ-ACK for at least one of activation DCI and release DCI. The UE may feed back (transmit) the HARQ-ACK by using a PUCCH, a PUSCH, or a medium access control (MAC) control element.

On the other hand, the UE may omit (may not support) the transmission of the plurality of pieces of HARQ-ACK for the plurality of PDSCHs respectively received in the plurality of SPS occasions configured by the one piece or more pieces of SPS configuration information.

Alternatively, the UE may support the transmission of the plurality of pieces of HARQ-ACK as described in at least one of the first to third aspects.

Alternatively, the UE may control, on the basis of trigger information (also referred to as polling, instruction information, and the like), the transmission of the plurality of pieces of HARQ-ACK to the plurality of PDSCHs respectively received in the plurality of SPS occasions configured by the one piece or more pieces of SPS configuration information. The trigger information may be DCI or MAC CE.

The resource used for the transmission of the plurality of pieces of HARQ-ACK may be at least one of one or more PUCCHs, one or more PUSCHs, or one or more MAC CEs.

The resource used for the transmission of the HARQ-ACK may be designated by at least one of a higher layer parameter, DCI (PDCCH), or a MAC CE. Incidentally, the DCI or the MAC CE may be referred to as an L1 indication or the like.

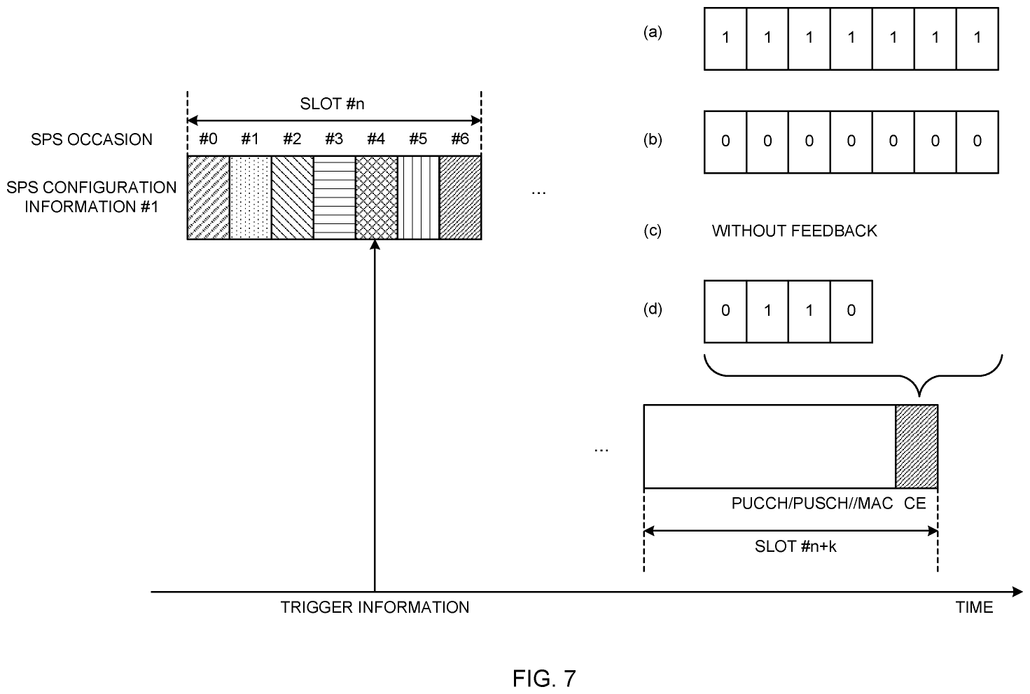

FIG. 7 is a diagram illustrating an example of HARQ-ACK feedback based on the trigger information according to the fourth aspect. Incidentally, FIG. 7 illustrates an example of applying the HARQ-ACK feedback according to the second aspect, but it is a matter of course that the HARQ-ACK feedback according to the first aspect can be applied.

In FIG. 7, description of points similar to those in FIG. 4 will be omitted, and differences from FIG. 4 will be mainly described. FIG. 7 is different from FIG. 4 in that HARQ-ACK for a plurality of PDSCHs respectively received in a plurality of SPS occasions in a predetermined window is fed back in a case where the trigger information is detected.

In FIG. 7, in a case where the UE detects the trigger information, the UE may control the feedback of the HARQ-ACK corresponding to at least one SPS opportunity in the predetermined window. Alternatively, the UE may control the feedback of the HARQ-ACK corresponding to at least one predetermined HARQ process ID in the case of detecting the trigger information. The predetermined HARQ process ID may be all HARQ process IDs that may be allocated to an SPS opportunity, may be all HARQ process IDs that may be allocated to a PDSCH dynamically scheduled on an SPS opportunity or a PDCCH, or may be one or more HARQ process IDs designated in the trigger information.

As illustrated in FIG. 7, in a case where the trigger information is detected in the middle of a predetermined window (slot #n), the UE may transmit (a) ACK or (b) NACK for all SPS occasions in the predetermined window. Alternatively, (c) in the case of detecting the trigger information in the middle of the predetermined window, the UE may not feed back the HARQ-ACK for all the SPS occasions in the predetermined window. Alternatively, (d) the UE may feed back the HARQ-ACK for the SPS opportunity until detecting the trigger information.

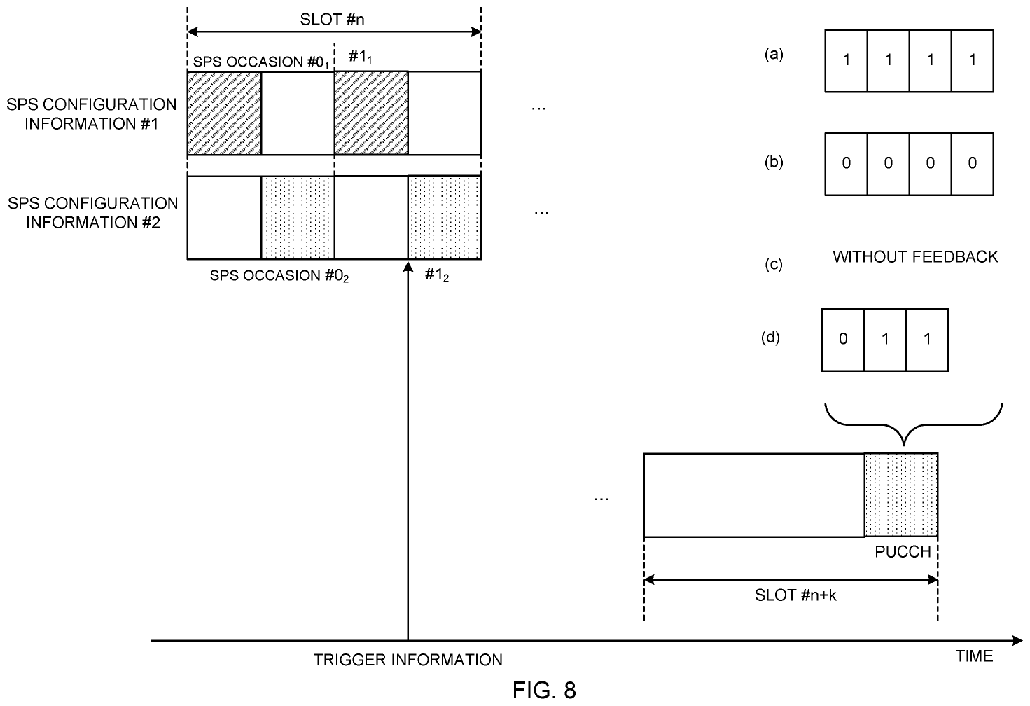

FIG. 8 is a diagram illustrating another example of the HARQ-ACK feedback based on the trigger information according to the fourth aspect. FIG. 8 is different from FIG. 7 in that one or more SPS occasions corresponding to different SPS configuration information are configured in a predetermined window (here, the slot #n). In FIG. 8, description of points similar to those in FIG. 7 will be omitted, and differences from FIG. 7 will be mainly described.

In FIG. 8, in a case where the UE detects the trigger information, the UE may control the feedback of the HARQ-ACK corresponding to at least one SPS opportunity configured by a plurality of pieces of SPS configuration information within the predetermined window.

As illustrated in FIG. 8, in a case where the trigger information is detected in the middle of a predetermined window (slot #n), the UE may transmit (a) ACK or (b) NACK for all SPS occasions in the predetermined window. Alternatively, (c) in the case of detecting the trigger information in the middle of the predetermined window, the UE may not feed back the HARQ-ACK for all the SPS occasions in the predetermined window. Alternatively, (d) the UE may feed back the HARQ-ACK for the SPS opportunity until detecting the trigger information.

Although not illustrated, the UE may feed back HARQ-ACK corresponding to one or more SPS occasions of specific SPS configuration information (for example, the SPS configuration information #1) according to the trigger information. The trigger information may include information indicating the specific SPS configuration information.

Although not illustrated, the UE may feed back HARQ-ACK of a specific HARQ process (or SPS opportunity) according to the trigger information. The trigger information may include information indicating the specific HAR process ID or the index of the SPS opportunity.

(Another Aspect)

Repeated transmission may be applied to the SPS (PDSCH reception in a plurality of SPS occasions of a certain periodicity) described in the first to fourth aspects. Further, an example in which activation or release of the SPS described in the first to fourth aspects is controlled by DCI has been described, but the SPS is not limited thereto. The SPS may be activated by the SPS configuration information, and activation or release may not be controlled by the DCI.

(Radio Communication System)

Hereinafter, a configuration of a radio communication system according to one embodiment of the present disclosure will be described. In this radio communication system, communication is performed using one or a combination of the radio communication methods according to the embodiments of the present disclosure.

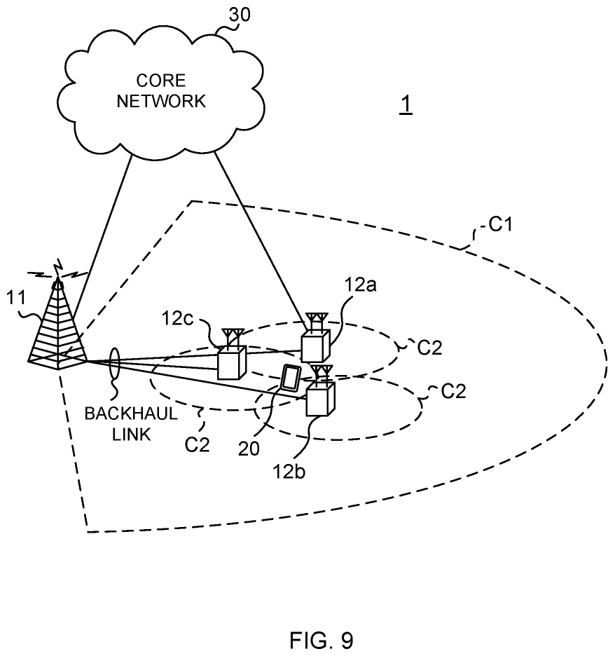

FIG. 9 is a diagram illustrating an example of a schematic configuration of a radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA Dual Connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as base stations 10 unless specified otherwise.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range 1 (FR1) and a second frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like of FR1 and FR2 are not limited thereto, and, for example, FR1 may correspond to a frequency range higher than FR2.

Further, the user terminal 20 may perform communication in each CC using at least one of time division duplex (TDD) and frequency division duplex (FDD).

The plurality of base stations 10 may be connected by wire (for example, an optical fiber or an X2 interface in compliance with common public radio interface (CPRI)) or wirelessly (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), and the like.

The user terminal 20 may be a terminal corresponding to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a downlink shared channel (physical downlink shared channel (PDSCH)) shared by each user terminal 20, a broadcast channel (physical broadcast channel (PBCH)), a downlink control channel (physical downlink control channel (PDCCH)), or the like may be used.

Further, in the radio communication system 1, as an uplink channel, an uplink shared channel (physical uplink shared channel (PUSCH)) shared by each user terminal 20, an uplink control channel (physical uplink control channel (PUCCH)), a random access channel (physical random access channel (PRACH)), or the like may be used.

User data, higher layer control information, and a system information block (SIB) and the like are transmitted by the PDSCH. The PUSCH may transmit user data, higher layer control information, and the like. Further, the PBCH may transmit a master information block (MIB).

The PDCCH may transmit lower layer control information. The lower layer control information may include, for example, downlink control information (DCI) including scheduling information of at least one of the PDSCH and the PUSCH.

Note that DCI for scheduling the PDSCH may be referred to as DL assignment, DL DCI, or the like, and DCI for scheduling the PUSCH may be referred to as UL grant, UL DCI, or the like. Note that the PDSCH may be replaced with DL data, and the PUSCH may be replaced with UL data.

A control resource set (CORESET) and a search space may be used to detect the PDCCH. The CORESET corresponds to a resource that searches for DCI. The search space corresponds to a search area and a search method for PDCCH candidates. One CORESET may be associated with one or a plurality of search spaces. The UE may monitor the CORESET associated with a certain search space on the basis of search space configuration.

One search space may correspond to a PDCCH candidate corresponding to one or a plurality of aggregation levels. One or a plurality of search spaces may be referred to as a search space set. Note that “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery confirmation information (which may be referred to as, for example, hybrid automatic repeat request acknowledgement (HARQ-ACK), ACK/NACK, or the like), scheduling request (SR), and the like may be transmitted by the PUCCH. By means of the PRACH, a random access preamble for establishing a connection with a cell may be transmitted.

Note that in the present disclosure, downlink, uplink, and the like may be expressed without “link”. Further, various channels may be expressed without adding “physical” at the beginning thereof.

In the radio communication system 1, a synchronization signal (SS), a downlink reference signal (DL-RS), and the like may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like may be transmitted as the DL-RS.

The synchronization signal may be, for example, at least one of a primary synchronization signal (PSS) and a secondary synchronization signal (SSS). A signal block including SS (PSS or SSS) and PBCH (and DMRS for PBCH) may be referred to as an SS/PBCH block, an SS Block (SSB), and the like. Note that the SS, the SSB, or the like may also be referred to as a reference signal.

Further, in the radio communication system 1, a sounding reference signal (SRS), a demodulation reference signal (DMRS), and the like may be transmitted as an uplink reference signal (UL-RS). Note that, the DMRS may be referred to as a “user terminal-specific reference signal (UE-specific reference signal)”.

(Base Station)

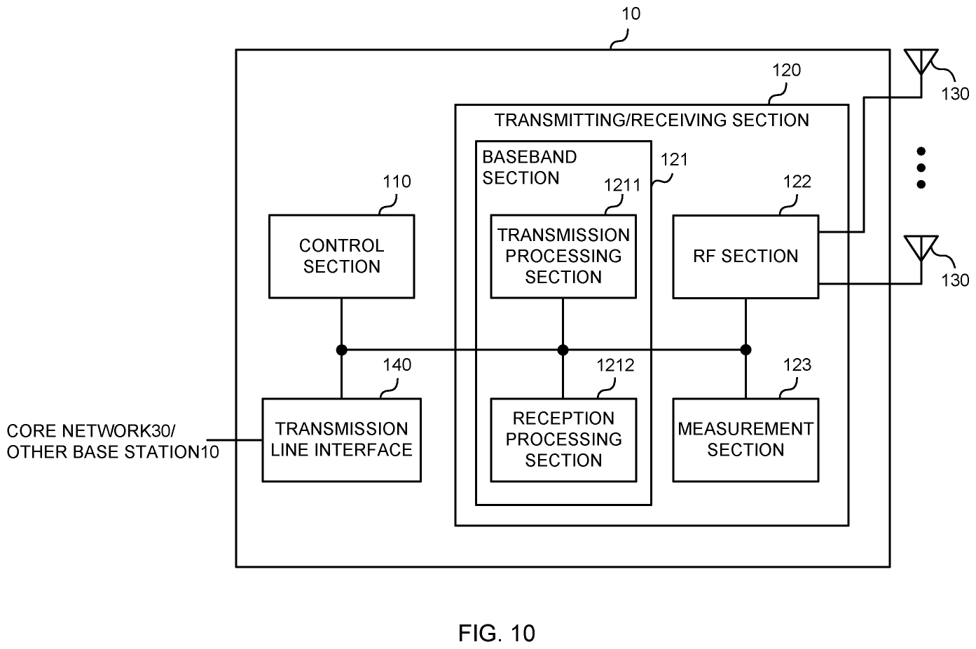

FIG. 10 is a diagram illustrating an example of a configuration of a base station according to one embodiment. The base station 10 includes a control section 110, a transmitting/receiving section 120, a transmission/reception antenna 130, and a transmission line interface 140. Note that one or more of the control sections 110, one or more of the transmitting/receiving sections 120, one or more of the transmission/reception antennas 130, and one or more of the transmission line interfaces 140 may be included.

Note that, although this example primarily indicates functional blocks of characteristic parts of the present embodiment, it may be assumed that the base station 10 has other functional blocks that are necessary for radio communication as well. A part of processing of each section described below may be omitted.

The control section 110 controls the entire base station 10. The control section 110 can be configured by a controller, a control circuit, or the like, which is described on the basis of common recognition in the technical field to which the present disclosure relates.

The control section 110 may control signal generation, scheduling (for example, resource assignment or mapping), and the like. The control section 110 may control transmission/reception, measurement, and the like using the transmitting/receiving section 120, the transmission/reception antenna 130, and the transmission line interface 140. The control section 110 may generate data to be forwarded as a signal, control information, a sequence, and the like, and may forward the data, the control information, the sequence, and the like to the transmitting/receiving section 120. The control section 110 may perform call processing (such as configuration or release) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can be configured by a transmitter/receiver, an RF circuit, a base band circuit, a filter, a phase shifter, a measurement circuit, a transmission/reception circuit, and the like, which are described on the basis of common recognition in the technical field to which the present disclosure relates.

The transmitting/receiving section 120 may be configured as an integrated transmitting/receiving section, or may be constituted by a transmitting section and a receiving section. The transmitting section may be configured by the transmission processing section 1211 and the RF section 122. The receiving section may be configured by the reception processing section 1212, the RF section 122, and the measurement section 123.

The transmission/reception antenna 130 can be configured by an antenna described on the basis of common recognition in the technical field to which the present disclosure relates, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam and a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like, for example, on data or control information acquired from the control section 110 to generate a bit string to be transmitted.

The transmitting/receiving section 120 (transmission processing section 1211) may perform transmission processing such as channel encoding (which may include error correcting encoding), modulation, mapping, filtering processing, discrete Fourier transform (DFT) processing (if necessary), inverse fast Fourier transform (IFFT) processing, precoding, or digital-analog transform on the bit string to be transmitted, and may output a base band signal.

The transmitting/receiving section 120 (RF section 122) may perform modulation to a radio frequency band, filtering processing, amplification, and the like on the base band signal, and may transmit a signal in the radio frequency band via the transmission/reception antenna 130.

On the other hand, the transmitting/receiving section 120 (RF section 122) may perform amplification, filtering processing, demodulation to a base band signal, and the like on the signal in the radio frequency band received by the transmission/reception antenna 130.

The transmitting/receiving section 120 (reception processing section 1212) may apply reception processing such as analog-digital transform, fast Fourier transform (FFT) processing, inverse discrete Fourier transform (IDFT) processing (if necessary), filtering processing, demapping, demodulation, decoding (which may include error correcting decoding), MAC layer processing, RLC layer processing, or PDCP layer processing on the acquired base band signal to acquire user data and the like.

The transmitting/receiving section 120 (measurement section 123) may perform measurement on the received signal. For example, the measurement section 123 may perform radio resource management (RRM) measurement, channel state information (CSI) measurement, and the like on the basis of the received signal. The measurement section 123 may measure received power (for example, reference signal received power (RSRP)), received quality (for example, reference signal received quality (RSRQ), a signal to interference plus noise ratio (SINR), or a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, other base stations 10, and the like, and may acquire, transmit, and the like user data (user plane data), control plane data, and the like for the user terminal 20.

Note that the transmitting section and the receiving section of the base station 10 in the present disclosure may be configured by at least one of the transmitting/receiving section 120, the transmission/reception antenna 130, and the transmission line interface 140.

Note that the transmitting/receiving section 120 may transmit one piece or more pieces of SPS configuration information (configuration information) indicating a periodicity shorter than one slot. The transmitting/receiving section 120 may transmit downlink control information used for activating or releasing reception of a plurality of PDSCHs (downlink shared channel) of a certain periodicity configured by each SPS configuration information. The transmitting/receiving section 120 may transmit trigger information of feedback of HARQ-ACK.

The control section 110 may control transmission of a plurality of PDSCHs (downlink shared channel) in each of a plurality of SPS occasions (reception occasions (opportunities)) configured by the SPS configuration information. The control section 110 may control reception of a plurality of pieces of HARQ-ACK (delivery confirmation information) for the plurality of PDSCHs.

The control section 110 may control reception of the plurality of pieces of HARQ-ACK using a plurality of PUCCHs (uplink control channels) corresponding to each of the plurality of SPS occasions (first aspect).

The control section 110 may control reception of the plurality of pieces of HARQ-ACK using a single PUCCH corresponding to one of the plurality of SPS occasions (second aspect).

The control section 110 may control reception of at least one of a plurality of pieces of HARQ-ACK for a plurality of PDSCHs respectively received in a plurality of SPS occasions transmitted on the basis of trigger information (fourth aspect).

The control section 110 may control reception of the delivery confirmation information for the downlink control information using a PUCCH (uplink control channel), a PUSCH (uplink shared channel), or a medium access control (MAC) control element.

The control section 110 may control transmission (or retransmission) of the PDSCH in each HARQ process on the basis of the delivery confirmation information.

(User Terminal)

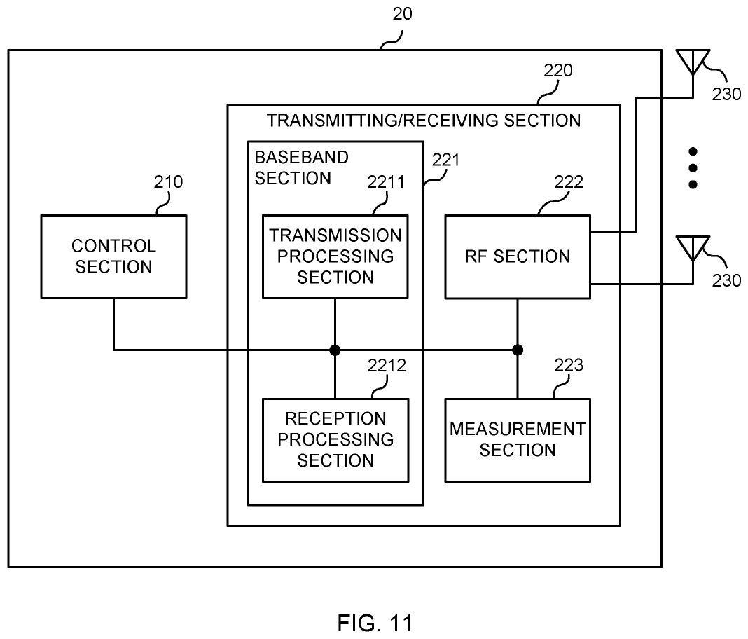

FIG. 11 is a diagram illustrating an example of a configuration of a user terminal according to one embodiment. The user terminal 20 includes a control section 210, a transmitting/receiving section 220, and a transmission/reception antenna 230. Note that one or more of the control sections 210, one or more of the transmitting/receiving sections 220, and one or more of the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can be configured by a controller, a control circuit, or the like, which is described on the basis of common recognition in the technical field to which the present disclosure relates.

The control section 210 may control signal generation, mapping, and the like. The control section 210 may control transmission/reception, measurement, and the like using the transmitting/receiving section 220 and the transmission/reception antenna 230. The control section 210 may generate data to be transmitted as a signal, control information, a sequence, and the like, and may forward the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be configured by a transmitter/receiver, an RF circuit, a base band circuit, a filter, a phase shifter, a measurement circuit, a transmission/reception circuit, and the like, which are described on the basis of common recognition in the technical field to which the present disclosure relates.

The transmitting/receiving section 220 may be configured as an integrated transmitting/receiving section, or may be configured by a transmitting section and a receiving section. The transmitting section may be configured by the transmission processing section 2211 and the RF section 222. The receiving section may be constituted by the reception processing section 2212, the RF section 222, and the measurement section 223.

The transmission/reception antenna 230 can be configured by an antenna described on the basis of common recognition in the technical field to which the present disclosure relates, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data acquired from the control section 210 or control information to generate a bit string to be transmitted.

The transmitting/receiving section 220 (transmission processing section 2211) may perform transmission processing such as channel encoding (which may include error correcting encoding), modulation, mapping, filtering processing, DFT processing (if necessary), IFFT processing, precoding, or digital-analog transform on a bit string to be transmitted, and may output a base band signal.

Note that whether or not to apply DFT processing may be determined on the basis of configuration of transform precoding. When transform precoding is enabled for a channel (for example, PUSCH), the transmitting/receiving section 220 (transmission processing section 2211) may perform DFT processing as the transmission processing in order to transmit the channel using a DFT-s-OFDM waveform. When transform precoding is not enabled for a channel (for example, PUSCH), the transmitting/receiving section 220 (transmission processing section 2211) may not perform DFT processing as the transmission processing.

The transmitting/receiving section 220 (RF section 222) may perform modulation to a radio frequency band, filtering processing, amplification, and the like on the base band signal, and may transmit a signal in the radio frequency band via the transmission/reception antenna 230.

On the other hand, the transmitting/receiving section 220 (RF section 222) may perform amplification, filtering processing, demodulation to a base band signal, and the like on the signal in the radio frequency band received by the transmission/reception antenna 230.

The transmitting/receiving section 220 (reception processing section 2212) may acquire user data and the like by applying reception processing such as analog-digital transform, FFT processing, IDFT processing (if necessary), filtering processing, demapping, demodulation, decoding (which may include error correcting decoding), MAC layer processing, RLC layer processing, or PDCP layer processing on the acquired base band signal.

The transmitting/receiving section 220 (measurement section 223) may perform measurement on the received signal. For example, the measurement section 223 may perform RRM measurement, CSI measurement, and the like on the basis of the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may be constituted by at least one of the transmitting/receiving section 220, the transmission/reception antenna 230, and the transmission line interface 240.

Note that the transmitting/receiving section 220 may receive one piece or more pieces of SPS configuration information (configuration information) indicating a periodicity shorter than one slot. The transmitting/receiving section 220 may receive downlink control information used for activating or releasing reception of a plurality of PDSCHs (downlink shared channel) of a certain periodicity configured by each SPS configuration information.

The control section 210 may control transmission of a plurality of pieces of HARQ-ACK (delivery confirmation information) for a plurality of PDSCHs (downlink shared channels) respectively received in a plurality of SPS occasions (reception occasions) configured by the SPS configuration information.

The control section 210 may control transmission of the plurality of pieces of HARQ-ACK using a plurality of PUCCHs (uplink control channels) corresponding to each of the plurality of SPS occasions (first aspect).

The control section 210 may control transmission of the plurality of pieces of HARQ-ACK using a single PUCCH corresponding to one of the plurality of SPS occasions (second aspect).

The control section 210 may control bundling of at least a part of the plurality of pieces of HARQ-ACK transmitted using the single PUCCH (third aspect).

The control section 210 may control transmission of at least one of a plurality of pieces of HARQ-ACK for a plurality of PDSCHs respectively received in a plurality of SPS occasions on the basis of trigger information (fourth aspect).

The control section 210 may control, on the basis of the downlink control information, activation or release of reception of a plurality of PDSCHs of a certain periodicity configured by each SPS configuration information.

The control section 210 may control transmission of delivery confirmation information for the downlink control information using a PUCCH (uplink control channel), a PUSCH (uplink shared channel), or a medium access control (MAC) control element.

(Hardware Configuration)

Note that the block diagrams that have been used to describe the above embodiments illustrate blocks in functional units. These functional blocks (configuration units) may be implemented in arbitrary combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (using wire, wireless, or the like, for example) and using these plural apparatuses. The functional blocks may be implemented by combining software with the above-described single apparatus or the above-described plurality of apparatuses.

Here, the function includes, but is not limited to, determining, deciding, judging, calculating, computing, processing, deriving, investigating, searching, ascertaining, receiving, transmitting, outputting, accessing, solving, selecting, choosing, establishing, comparing, assuming, expecting, considering, broadcasting, notifying, communicating, forwarding, configuring, reconfiguring, allocating, mapping, and assigning. For example, a functional block (configuration unit) that causes transmission to function may be referred to as a transmitting unit, a transmitter, and the like. In any case, as described above, the implementation method is not particularly limited.

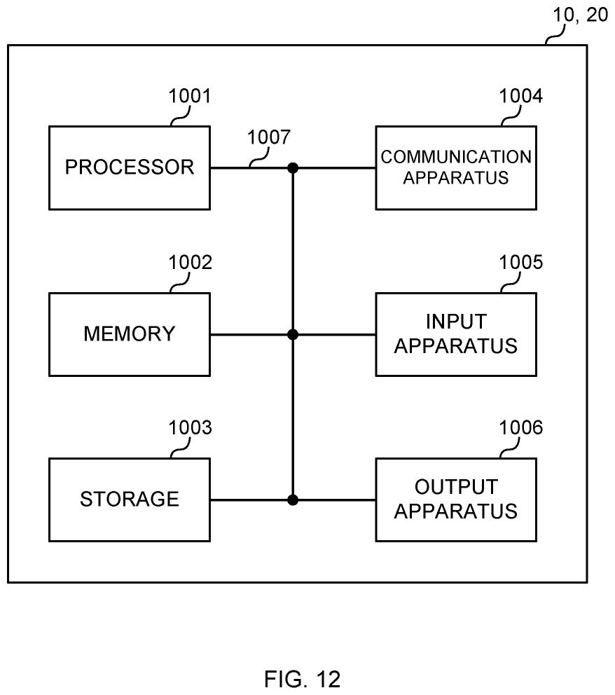

For example, the base station, the user terminal, and the like according to one embodiment of the present disclosure may function as a computer that executes the processing of the radio communication method of the present disclosure. FIG. 12 is a diagram illustrating an example of a hardware configuration of the base station and the user terminal according to one embodiment. Physically, the above-described base station 10 and user terminal 20 may be configured as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, or a unit can be replaced with each other. The hardware configuration of the base station 10 and the user terminal 20 may be configured to include one or a plurality of apparatuses illustrated in the drawings, or may be configured without including some apparatuses.

For example, although only one processor 1001 is illustrated, a plurality of processors may be provided. Further, the processing may be executed by one processor, or the processing may be executed in sequence or using other different methods simultaneously by two or more processors. Note that the processor 1001 may be implemented with one or more chips.

Each function of the base station 10 and the user terminal 20 is implemented by the processor 1001. For example, the processor 1001 performs operations by causing a predetermined software (program) to be read on hardware such as the memory 1002 to control communication via the communication apparatus 1004 and control at least one of reading and writing of data in the memory 1002 and the storage 1003.

The processor 1001 may control the whole computer by, for example, operating an operating system. The processor 1001 may be configured by a central processing unit (CPU) including an interface with peripheral equipment, a control device, an operation device, a register, and the like. For example, at least a part of the above-described control section 110 (210), transmitting/receiving section 120 (220), and the like may be implemented by the processor 1001.

The processor 1001 reads a program (program code), a software module, data, and the like from at least one of the storage 1003 and the communication apparatus 1004 into the memory 1002, and executes various pieces of processing in according therewith. As the program, a program to cause a computer to execute at least a part of the operation described in the above-described embodiment is used. For example, the control section 110 (210) may be implemented by a control program that is stored in the memory 1002 and operates in the processor 1001, and another functional block may be implemented similarly.

The memory 1002 is a computer-readable recording medium, and may be configured by, for example, at least one of a read only memory (ROM), an erasable programmable ROM (EPROM), an electrically EPROM (EEPROM), a random access memory (RAM) and/or other appropriate storage media. The memory 1002 may be referred to as a “register”, a “cache”, a “main memory (primary storage apparatus)”, and the like. The memory 1002 can store a program (program code), a software module, and the like, which are executable for implementing the radio communication method according to one embodiment of the present disclosure.

The storage 1003 is a computer-readable recording medium, and may be configured by, for example, at least one of a flexible disk, a floppy (registered trademark) disk, a magneto-optical disk (for example, a compact disc ROM (CD-ROM) and the like), a digital versatile disc, a Blu-ray (registered trademark) disk), a removable disk, a hard disk drive, a smart card, a flash memory device (for example, a card, a stick, a key drive), a magnetic stripe, a database, a server, and other appropriate storage media. The storage 1003 may be referred to as an auxiliary storage apparatus.

The communication apparatus 1004 is hardware (transmission/reception device) for allowing inter-computer communication by using at least one of a wired network and a wireless network, and may be referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) and time division duplex (TDD). For example, the transmitting/receiving section 120 (220), the transmission/reception antenna 130 (230), and the like described above may be implemented by the communication apparatus 1004. The transmitting/receiving section 120 (220) may be implemented by physically or logically separating a transmitting section 120a (220a) and a receiving section 120b (220b) from each other.

The input apparatus 1005 is an input device for receiving input from the outside (for example, a keyboard, a mouse, a microphone, a switch, a button, a sensor, and the like). The output apparatus 1006 is an output device that performs output to the outside (for example, a display, a speaker, a light emitting diode (LED) lamp, and the like). Note that the input apparatus 1005 and the output apparatus 1006 may be provided in an integrated structure (for example, a touch panel).

Each apparatus such as the processor 1001 and the memory 1002 is connected by the bus 1007 for communicating information. The bus 1007 may be configured by a single bus, or may be configured by buses that vary between apparatuses.

The base station 10 and the user terminal 20 may include hardware such as a microprocessor, a digital signal processor (DSP), an application specific integrated circuit (ASIC), a programmable logic device (PLD), and a field programmable gate array (FPGA), and a part or all of each functional block may be implemented by the hardware. For example, the processor 1001 may be implemented with at least one of these pieces of hardware.

(Modification)

Note that terms described in the present disclosure and terms necessary for understanding the present disclosure may be replaced with terms that have the same or similar meanings. For example, a channel, a symbol, and a signal (signal or signaling) may be replaced interchangeably. Further, the signal may be a message. The reference signal can be abbreviated as an RS, and may be referred to as a pilot, a pilot signal and the like, depending on which standard applies. Further, a component carrier (CC) may be referred to as a cell, a frequency carrier, a carrier frequency, and the like.

A radio frame may include one or a plurality of periods (frames) in a time domain. Each of the one or plurality of periods (frames) included in the radio frame may be referred to as a subframe. Further, the subframe may include one or more slots in the time domain. The subframe may be a fixed time length (for example, 1 ms) not dependent on numerology.

Here, the numerology may be a communication parameter applied to at least one of transmission and reception of a signal or a channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in a frequency domain, specific windowing processing performed by a transceiver in the time domain, and the like.

A slot may be configured by one or a plurality of symbols in the time domain (orthogonal frequency division multiplexing (OFDM) symbols, single carrier frequency division multiple access (SC-FDMA) symbols, and the like). Also, a slot may be a time unit based on the numerology.

A slot may include a plurality of mini slots. Each mini slot may include one or a plurality of symbols in the time domain. Further, the mini slot may be referred to as a sub slot. Each mini slot may include fewer symbols than a slot. PDSCH (or PUSCH) transmitted in a time unit larger than a mini slot may be referred to as PDSCH (PUSCH) mapping type A. A PDSCH (or PUSCH) transmitted using a mini slot may be referred to as PDSCH (PUSCH) mapping type B.

A radio frame, a subframe, a slot, a mini slot and a symbol all represent the time unit in signal communication. The radio frame, the subframe, the slot, the mini slot, and the symbol may be called by other applicable names, respectively. Note that time units such as a frame, a subframe, a slot, a mini slot, and a symbol in the present disclosure may be replaced with each other.

For example, one subframe may be referred to as TTI, a plurality of contiguous subframes may be referred to as TTI, or one slot or one mini slot may be referred to as TTI. That is, at least one of the subframe and TTI may be a subframe (1 ms) in the existing LTE, may be a period shorter than 1 ms (for example, one to thirteen symbols), or may be a period longer than 1 ms. Note that the unit to represent the TTI may be referred to as a slot, a mini slot or the like, instead of a subframe.

Here, a TTI refers to the minimum time unit of scheduling in radio communication, for example. For example, in the LTE system, a base station performs scheduling to allocate radio resources (a frequency bandwidth and transmission power that can be used in each user terminal and the like) to each user terminal in TTI units. Note that the definition of TTIs is not limited to this.

The TTI may be a transmission time unit of channel-encoded data packets (transport blocks), code blocks, codewords, or the like, or may be a unit of processing in scheduling, link adaptation, and so on. Note that, when the TTI is given, a time interval (for example, the number of symbols) to which the transport block, code block, codeword, or the like is actually mapped may be shorter than the TTI.

Note that, when one slot or one mini slot is referred to as a TTI, one or more TTIs (that is, one or more slots or one or more mini slots) may be the minimum time unit of scheduling. Further, the number of slots (the number of mini slots) configuring the minimum time unit of scheduling may be controlled.

A TTI having a time length of 1 ms may be referred to as a usual TTI (TTI in 3GPP Rel. 8 to 12), a normal TTI, a long TTI, a usual subframe, a normal subframe, a long subframe, a slot, and the like. A TTI that is shorter than the usual TTI may be referred to as a shortened TTI, a short TTI, a partial TTI (or fractional TTI), a shortened subframe, a short subframe, a mini slot, a sub slot, a slot, and the like.

Note that a long TTI (for example, a usual TTI, a subframe, or the like) may be replaced with a TTI having a time length exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or a plurality of contiguous subcarriers in the frequency domain. The number of subcarriers included in the RB may be the same regardless of the numerology, and may be twelve, for example. The number of subcarriers included in the RB may be decided on the basis of the numerology.

Further, the RB may include one or a plurality of symbols in the time domain, and may have a length of one slot, one mini slot, one subframe, or one TTI. One TTI, one subframe, and the like each may be configured by one or a plurality of resource blocks.

Note that one or a plurality of RBs may be referred to as a physical resource block (physical RB (PRB)), a sub-carrier group (SCG), a resource element group (REG), a PRB pair, an RB pair, or the like.

Further, a resource block may include one or a plurality of resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. The PRB may be defined in a certain BWP and be numbered within the BWP.

The BWP may include BWP for UL (UL BWP) and BWP for DL (DL BWP). For the UE, one or a plurality of BWPs may be configured within one carrier.

At least one of the configured BWPs may be active, and it may not be assumed that the UE transmits and receives a predetermined signal/channel outside the active BWP. Note that cell, carrier, and the like in the present disclosure may be replaced with BWP.

Note that the structures of the above-described radio frame, subframe, slot, mini slot, symbol, and the like are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol duration, the length of cyclic prefix (CP), and the like can be variously changed.

Further, the information, parameters, and the like described in the present disclosure may be represented using absolute values or relative values with respect to predetermined values, or may be represented using other corresponding information. For example, a radio resource may be instructed by a predetermined index.

The names used for parameters and the like in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names assigned to these various channels and information elements are not restrictive names in any respect.

The information, signals, and the like described in the present disclosure may be represented by using any of a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Information, signals, and the like can be output at least one of from higher layer to lower layer and from lower layer to higher layer. Information, signals, and the like may be input and output via a plurality of network nodes.

The information, signals, and the like that are input and output may be stored in a specific location (for example, in a memory), or may be managed using a management table. The information, signal, and the like to be input and output can be overwritten, updated or appended. The output information, signal, and the like may be deleted. The information, signals, and the like that are input may be transmitted to another apparatus.

Notification of information may be performed not only by using the aspects/embodiments described in the present disclosure but also using another method. For example, notification of information in the present disclosure may be performed by using physical layer signaling (for example, downlink control information (DCI), uplink control information (UCI)), higher layer signaling (for example, radio resource control (RRC) signaling, broadcast information (master information block (MIB), system information block (SIB), or the like), medium access control (MAC) signaling), another signal, or a combination thereof.

Note that the physical layer signaling may be referred to as layer 1/layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of MAC signaling may be performed using, for example, a MAC control element (MAC CE).

Further, notification of predetermined information (for example, notification of “being X”) is not limited to explicit notification but may be performed implicitly (for example, by not performing notification of the predetermined information or by performing notification of another piece of information).

Judging may be performed using values represented by one bit (0 or 1), may be performed using Boolean values represented by true or false, or may be performed by comparing numerical values (for example, comparison with a predetermined value).

Regardless of whether referred to as software, firmware, middleware, microcode, or hardware description language, or referred to by other names, software should be broadly interpreted so as to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, instruction, information, and the like may be transmitted/received via a transmission medium. For example, when software is transmitted from a website, a server, or another remote source by using at least one of a wired technology (coaxial cable, optical fiber cable, twisted pair, digital subscriber line (DSL), or the like) and a wireless technology (infrared rays, microwaves, and the like), at least one of the wired technology and the wireless technology is included within the definition of a transmission medium.

The terms “system” and “network” used in the present disclosure can be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be interchangeably used.

In the present disclosure, the terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or a plurality of (for example, three) cells. In a case where the base station accommodates a plurality of cells, the entire coverage area of the base station can be partitioned into a plurality of smaller areas, and each smaller area can provide communication services through a base station subsystem (for example, small remote radio head (RRH) for indoors). The term “cell” or “sector” refers to a part or the whole of a coverage area of at least one of a base station and a base station subsystem that perform a communication service in this coverage.

In the present disclosure, the terms such as “mobile station (MS)”, “user terminal (user terminal)”, “user equipment (UE)”, and “terminal” can be used interchangeably.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or other appropriate terms.

At least one of the base station and the mobile station may be referred to as a transmission apparatus, a reception apparatus, a radio communication apparatus, and the like. Note that at least one of the base station and the mobile station may be a device mounted on a moving body, a moving body itself, and the like. The moving body may be a transportation (for example, a car, an airplane and the like), an unmanned moving body (for example, a drone, an autonomous car, and the like), or a (manned or unmanned) robot. Note that at least one of the base station and the mobile station also includes an apparatus that does not necessarily move during a communication operation. For example, at least one of the base station and the mobile station may be an Internet of Things (IoT) device such as a sensor.

The base station in the present disclosure may be replaced with a user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In the case, the user terminal 20 may have the function of the above-described base station 10. Further, terms such as “uplink” and “downlink” may be replaced with terms corresponding to communication between terminals (for example, “side”). For example, the uplink channel, the downlink channel, and the like may be replaced with a side channel.

Similarly, the user terminal in the present disclosure may be replaced with a base station. In this case, the base station 10 may be configured to have the above-described functions of the user terminal 20.

In the present disclosure, the operation performed by the base station may be performed by an upper node thereof in some cases. In a network including one or a plurality of network nodes including the base station, it is clear that various operations performed to communicate with terminals may be performed by the base station, one or a plurality of network nodes other than the base station (for example, mobility management entity (MME), serving-gateway (S-GW), and the like are conceivable, but there is no limitation), or a combination thereof.

Each aspect/embodiment described in the present disclosure may be used alone, used in combination, or switched in association with execution. Further, the order of processing procedures, sequences, flowcharts, and the like of the aspects/embodiments described in the present disclosure may be re-ordered as long as there is no inconsistency. For example, regarding the methods described in the present disclosure, elements of various steps are presented using an illustrative order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded on the basis of these, and the like. Further, a plurality of systems may be combined (for example, a combination of LTE or LTE-A and 5G) and applied.

The term “on the basis of” used in the present disclosure does not mean “only on the basis of” unless otherwise specified. In other words, the term “on the basis of” means both “only on the basis of” and “at least on the basis of”.

Any reference to an element using designations such as “first” and “second” used in the present disclosure does not generally limit the amount or order of these elements. These designations may be used in the present disclosure only for convenience, as a method for distinguishing between two or more elements. In this way, reference to the first and second elements does not imply that only two elements may be employed, or that the first element must precede the second element in some way.

The term “determining (deciding)” used in the present disclosure may include a wide variety of operations. For example, “determining (deciding)” may be regarded as “determining (deciding)” of judging, calculating, computing, processing, deriving, investigating, looking up, search, inquiry (for example, looking up in a table, database, or another data structure), ascertaining, and the like.

Further, “determining (deciding)” may be regarded as “determining (deciding)” of receiving (for example, receiving information), transmitting (for example, transmitting information), input, output, accessing (for example, accessing data in a memory), and the like.

Further, “determining (deciding)” may be regarded as “determining” of resolving, selecting, choosing, establishing, comparing, and the like. That is, “determining (deciding)” may be regarded as “determining (deciding)” some operations.

Further, “determining (deciding)” may be replaced with “assuming”, “expecting”, “considering”, and the like.

The “maximum transmission power” described in the present disclosure may mean a maximum value of transmission power, the nominal UE maximum transmit power, or the rated UE maximum transmit power.

As used in the present disclosure, the terms “connected” and “coupled”, or any variation of these terms mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be replaced with “access”.

As used in the present disclosure, when two elements are connected, these elements may be considered “connected” or “coupled” to each other by using one or more electrical wires, cables, printed electrical connections, and the like, and, as a number of non-limiting and non-inclusive examples, by using electromagnetic energy having wavelengths in a radio frequency domain, a microwave domain, and an optical (both visible and invisible) domain, or the like.

In the present disclosure, the description of “A and B are different” may mean “A and B are different from each other”. Note that the description may mean that “A and B are different from C”. The terms such as “separated”, “coupled”, and the like may be interpreted as “different”.

When the terms such as “include”, “including”, and variations of these are used in the present disclosure, these terms are intended to be inclusive, in a manner similar to the way the term “comprising” is used. Further, the term “or” as used in the present disclosure is intended to be not an exclusive-OR.

In the present disclosure, for example, when translations add articles, such as a, an, and the in English, the present disclosure may include that the noun that follows these articles is in the plural.

Now, although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined on the basis of the description of claims. Therefore, the description in the present disclosure is provided for the purpose of describing examples, and thus, should by no means be construed to limit the invention according to the present disclosure in any way.

1. A user terminal comprising:
a receiving section that receives one or more pieces of configuration information indicating a periodicity shorter than one slot; and
a control section that controls transmission of a plurality of pieces of delivery confirmation information for a plurality of downlink shared channels, the plurality of pieces of delivery confirmation information being respectively received in a plurality of reception occasions configured by the configuration information.

2. The user terminal according to claim 1, wherein the control section controls transmission of the plurality of pieces of delivery confirmation information using a plurality of uplink control channels respectively corresponding to the plurality of reception occasions or using a single uplink control channel corresponding to one of the plurality of reception occasions.

3. The user terminal according to claim 2, wherein the control section controls bundling of at least some of the plurality of pieces of delivery confirmation information transmitted by using the single uplink control channel.

4. The user terminal according to claim 1, wherein the control section controls transmission of at least one of the plurality of pieces of delivery confirmation information on the basis of trigger information.

5. The user terminal according to claim 1, wherein
the receiving section receives downlink control information used to activate or release reception of the plurality of downlink shared channels, and
the control section controls transmission of the delivery confirmation information for the downlink control information using an uplink control channel, an uplink shared channel, or a medium access control (MAC) control element.

6. A radio communication method comprising:
receiving one or more pieces of configuration information indicating a periodicity shorter than one slot; and
controlling transmission of a plurality of pieces of delivery confirmation information for a plurality of downlink shared channels, the plurality of pieces of delivery confirmation information being respectively received in a plurality of reception occasions configured by the configuration information.

7. The user terminal according to claim 2, wherein the control section controls transmission of at least one of the plurality of pieces of delivery confirmation information on the basis of trigger information.

8. The user terminal according to claim 3, wherein the control section controls transmission of at least one of the plurality of pieces of delivery confirmation information on the basis of trigger information.

9. The user terminal according to claim 2, wherein
the receiving section receives downlink control information used to activate or release reception of the plurality of downlink shared channels, and
the control section controls transmission of the delivery confirmation information for the downlink control information using an uplink control channel, an uplink shared channel, or a medium access control (MAC) control element.

10. The user terminal according to claim 3, wherein
the receiving section receives downlink control information used to activate or release reception of the plurality of downlink shared channels, and
the control section controls transmission of the delivery confirmation information for the downlink control information using an uplink control channel, an uplink shared channel, or a medium access control (MAC) control element.

11. The user terminal according to claim 4, wherein
the receiving section receives downlink control information used to activate or release reception of the plurality of downlink shared channels, and
the control section controls transmission of the delivery confirmation information for the downlink control information using an uplink control channel, an uplink shared channel, or a medium access control (MAC) control element.
